(19) United States
(12) Patent Application Publication
(10) Pub. No.: US 2021/0231502 A1
(43) Pub. Date: Jul. 29, 2021

(54) INFORMATION PROCESSING APPARATUS FOR HELPING INTUITIVE AND EASY RECOGNITION OF TEMPERATURE OF HEAT SOURCE

(71) Applicant: Panasonic Intellectual Property Management Co., Ltd., Osaka (JP)

(72) Inventors: Ryuichi OKAMOTO, Osaka (JP); Yusaku NAKAMURA, Osaka (JP); Masaki MUKAI, Hyogo (JP)

(21) Appl. No.: 17/233,497

(22) Filed: Apr. 18, 2021

Related U.S. Application Data
(63) Continuation of application No. PCT/JP2019/041311, filed on Oct. 21, 2019.

(30) Foreign Application Priority Data
Oct. 22, 2018 (JP) 2018-198408

(51) Int. Cl. G01J 5/60; G01J 5/02

(52) U.S. Cl. CPC G01J 5/605; G01J 2005/0077; G01J 5/025

(57) ABSTRACT

An infrared camera captures a subject to generate a thermal image thereof. A distance sensor detects distances from an information processing apparatus to points on the subject. A storage device stores a temperature-to-color conversion table indicative of correspondences between temperatures and pixel colors. A control device processes the thermal image based on the conversion table, to display the processed thermal image on a display device. The control device identifies a region of interest within a range of a predetermined distance from a reference point of the subject based on the distances detected by the distance sensor, sets lower and upper limits of a temperature range based on temperatures of points within the region of interest, updates the conversion table based on the lower and upper limits, and regenerates the thermal image based on the updated conversion table, to display the regenerated thermal image on the display device.

### CROSS-REFERENCE TO RELATED APPLICATIONS

This is a continuation application of international Application No. PCT/JP2019/041311, with an international filing date of Oct. 21, 2019, which claims priority of Japanese Patent Application No. 2018-198408 filed on Oct. 22, 2018, the content of which is incorporated herein by reference.

### BACKGROUND

### 1. Technical Field

The present disclosure relates to an information processing apparatus and an information processing method for capturing and displaying a thermal image indicating temperatures of a subject to be captured.

### 2. Description of Related Art

A thermal image is an image used for measuring temperatures of an object based on far-infrared rays emitted from the object. Since the temperatures of the object can be known from the thermal image, it is possible to identify, from a position remote from the object, locations with abnormal heat in the object, positions of water entered a pipe and the like in the object, or defective sites such as cavities in a wall. On the other hand, it is difficult to identify the actual position only using the thermal image, and therefore, it is devised to capture a visible image together with the thermal image to display both the thermal image and the visible image.

Japanese patent laid-open publication JP 2009-014475 A discloses a far-infrared radiation image processing apparatus configured to process an image taken by detecting far-infrared rays radiated from an object. The far-infrared image processing apparatus is provided with: an image signal reception section configured to receive an image signal indicative of a far-infrared radiation image taken by a far-infrared radiation camera; area designation reception means configured to receive area designation information input to designate a specific area of the far-infrared radiation image; and a resolution conversion section configured to convert the resolution for the amount of the far-infrared rays applicable to the specific area designated by the area designation information in the far-infrared radiation image, thereby creating resolution-converted image information. According to this configuration, the resolution for the amount of the far-infrared rays applicable to only the specific region of interest in the far-infrared radiation image is converted. That is, the resolution of the specific area can be set as desired, while the resolution of the image as a whole is maintained. This makes it possible to express in a more appropriate manner the area of particular interest of the object being imaged, while the overall image is presented.

### SUMMARY

One non-limiting and exemplary embodiment provides an information processing apparatus and an information processing method that enable a user to intuitively and easily recognize temperatures of a heat source.

According to a general aspect of the present disclosure, an information processing apparatus captures and displays a thermal image indicative of temperatures of a subject in colors. The information processing apparatus is provided with: an infrared camera, a distance sensor, a display device, a storage device, and a control device. The infrared camera captures the subject to generate the thermal image of the subject. The distance sensor detects distances from the information processing apparatus to points on the subject. The display device displays the thermal image. The storage device stores a temperature-to-color conversion table indicative of correspondences between temperatures of the subject and pixel colors. The control device processes the thermal image based on the temperature-to-color conversion table, to display the processed thermal image on the display device. The control device identifies a region of interest within a range of a predetermined distance from a reference point of the subject, based on the distances detected by the distance sensor. The control device sets lower and upper limits of a temperature range based on temperatures of points within the region of interest. The control device updates the temperature-to-color conversion table based on the lower and upper limits of the temperature range. The control device regenerates the thermal image based on the updated temperature-to-color conversion table, to display the regenerated thermal image on the display device.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

According to the information processing apparatus of the aspect of the present disclosure, the information processing apparatus displays the temperatures of the heat source so as to be intuitively and easily recognized. This makes it easier for the user to intuitively and easily recognize the temperatures of the heat source.

### BRIEF DESCRIPTION OF DRAWINGS

FIG. 1 is a block diagram showing a configuration of an information processing apparatus 10 according to an embodiment of the present disclosure;

FIG. 2 is a view showing an appearance of the information processing apparatus 10 of FIG. 1;

FIG. 3 is a view showing an appearance of the information processing apparatus 10 of FIG. 1;

FIG. 4 is a flowchart showing a temperature displaying process executed by a control device 11 of FIG. 1;

FIG. 5 is a flowchart showing a subroutine for a temperature value window drawing process at step S3 of FIG. 4;

FIG. 6 is a flowchart showing a subroutine for a temperature range adjustment process at step S6 of FIG. 4;

FIG. 7 is a view showing a preview image displayed on a display device 13 of FIG. 1;

FIG. 8 is a view showing an example of a temperature value window WD displayed on the display device 13 of FIG. 1;

FIG. 9 is a view showing another example of the temperature value window WD displayed on the display device 13 of FIG. 1;

FIG. 10 is a view explaining correspondences between temperatures and displayed colors, displayed on the display device 13 of FIG. 1;

FIG. 11 is a schematic view showing an arrangement of the information processing apparatus 10 of FIG. 1 and subjects 121 to 123 to be captured;

FIG. 12 is a view showing an example of the temperature value window WD displayed on the display device 13 of FIG. 1, in which changes in temperature values are less recognizable; and

FIG. 13 is a view showing an example of the temperature value window WD displayed on the display device 13 of FIG. 1, in which improvement has been made so that changes in temperature values are well recognizable.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art. It is to be noted that the inventor(s) intends to provide the accompanying drawings and the following description so that those skilled in the art can sufficiently understand the present disclosure, and does not intend to limit subject matters recited in the claims.

### Embodiment

[1-1. Configuration]

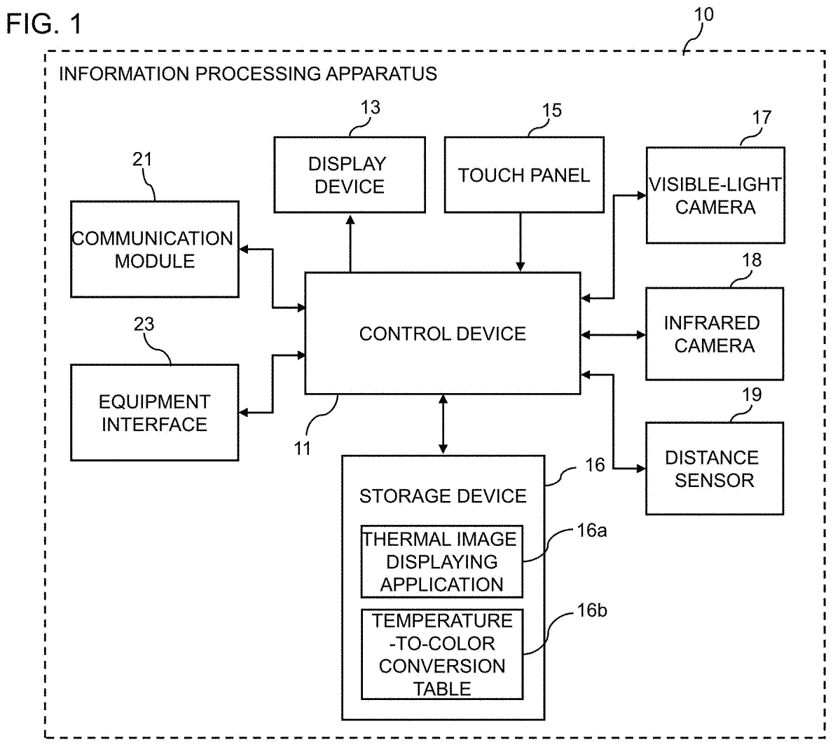

FIG. 1 is a block diagram showing a configuration of an information processing apparatus 10 according to an embodiment of the present disclosure. The information processing apparatus 10 is provided with a control device 11, a display device 13, a storage device 16, a visible-light camera 17, an infrared camera 18, a distance sensor 19, a communication module 21, and an equipment interface 23. The information processing apparatus 10 captures and displays a thermal image indicating temperatures of a subject to be captured (hereinafter, referred to simply as “subject”) in various colors.

The control device 11 controls overall operations of the information processing apparatus 10. The control device 11 includes a central processing unit (CPU), and performs functions of the information processing apparatus 10 as described below, by executing control programs. The control device 11 may be implemented only using hardware circuits designed dedicatedly to perform predetermined functions. The control device 11 may be composed of various circuits, such as a microprocessor unit (MPU), a graphics processing unit (GPU), a digital signal processor (DSP), a field programmable gate array (FPGA), and an application specific integrated circuit (ASIC), other than the CPU.

The display device 13 displays various information, such as visible images and thermal images of the subject. The display device 13 is, for example, a liquid crystal display or an organic electro-luminescence (EL) display.

A touch panel 15 receives user inputs. The touch panel 15 is an input device that detects touch operations with the user's finger or a stylus pen. The touch panel 15 is arranged so that its input area overlaps with a display area of the display device 13. In place of or in addition to the touch panel 15, the information processing apparatus 10 may be provided with, as the input device, buttons and/or slide switches physically disposed on the information processing apparatus 10. The information processing apparatus 10 can reduce or enlarge the image according to the user's operations on the touch panel 15 (e.g., pinch-in or pinch-out operation), for display on the display device 13.

The storage device 16 is a storage medium that stores data, parameters, control programs, and the like necessary to perform the functions of the information processing apparatus 10. The storage device 16 stores a thermal image displaying application 16a (control program) and a temperature-to-color conversion table 16b, for performing the functions of the information processing apparatus 10. The storage device 16 is, for example, a hard disk drive (HDD), a semiconductor storage device (Solid State Drive: SSD), and/or a semiconductor memory (Random Access Memory: RAM). The temperature-to-color conversion table 16b indicates correspondences between temperatures and colors of pixels in the thermal image of the subject generated by the infrared camera 18.

The visible-light camera 17 is an imaging device sensible to the wavelength region of visible light, and captures visible light from the subject at a predetermined frame rate, to generate an image (hereinafter, referred to as “visible image”). The infrared camera 18 is an imaging device sensible to the wavelength region of infrared rays, captures infrared rays from the subject at a predetermined frame rate, to generate an image whose pixels include information indicative of temperatures of the subject (hereinafter, referred to as “thermal image”).

The distance sensor 19 detects distances from the information processing apparatus 10 to points on the subject. For example, the distance sensor 19 may be a distance measuring device using a laser or infrared rays, or may be a stereo distance measuring device. The distance sensor 19 is implemented using various known techniques, such as the active stereo scheme or the time-of-flight (TOF) scheme. The distance sensor 19 is provided with, for example, an infrared projector and a pair of infrared cameras. A specific pattern is irradiated with infrared rays from the infrared projector, and then, the distance from the information processing apparatus 10 to the subject is calculated based on a difference between images captured by the pair of infrared cameras.

The visible-light camera 17, the infrared camera 18, and the distance sensor 19 are arranged so as to have substantially the same angle of view as each other to capture substantially the same subject, and so as to detect the distance from the information processing apparatus 10 to points on the same subject.

The communication module 21 is a circuit (module) for connecting to other devices via a network, and communicates with the other devices in accordance with the communication standard, such as 3G, 4G, LTE, WiMAX (registered trademark), or the like. The equipment interface 23 is a circuit (module) for connecting to external equipment, and communicates with the external equipment in accordance with the communication standard, such as USB (registered trademark), HDMI (registered trademark), Bluetooth (registered trademark), or the like.

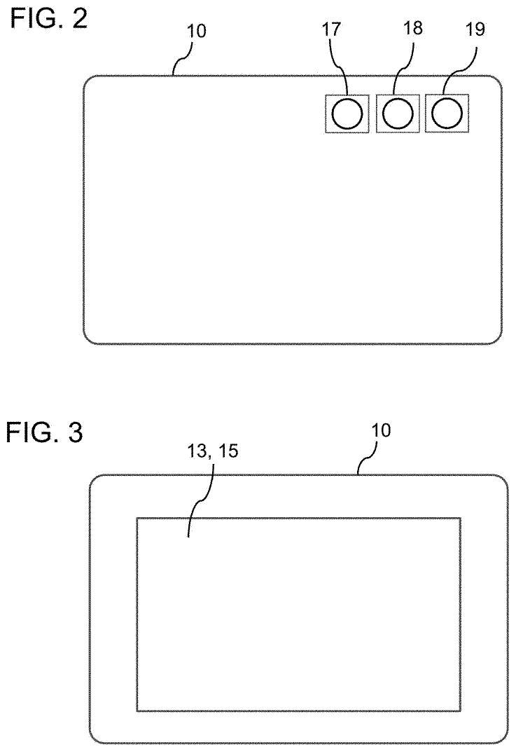

FIG. 2 is a view showing an appearance of the information processing apparatus 10 of FIG. 1. FIG. 3 is a view showing an appearance of the information processing apparatus 10 of FIG. 1. The information processing apparatus 10 is, for example, a tablet terminal device. FIG. 2 is a view of the information processing apparatus 10 seen from its back side, and FIG. 3 is a view of the information processing apparatus 10 seen from its front side. The information processing apparatus 10 has the visible-light camera 17, the infrared camera 18, and the distance sensor 19 on its back side. The information processing apparatus 10 has the display device 13, and the touch panel 15 arranged overlapping with the display device 13, on its front side.

[1-2. Operations]

Next, operations of the information processing apparatus 10 configured as above will be described.

[1-2-1. Temperature Displaying Process]

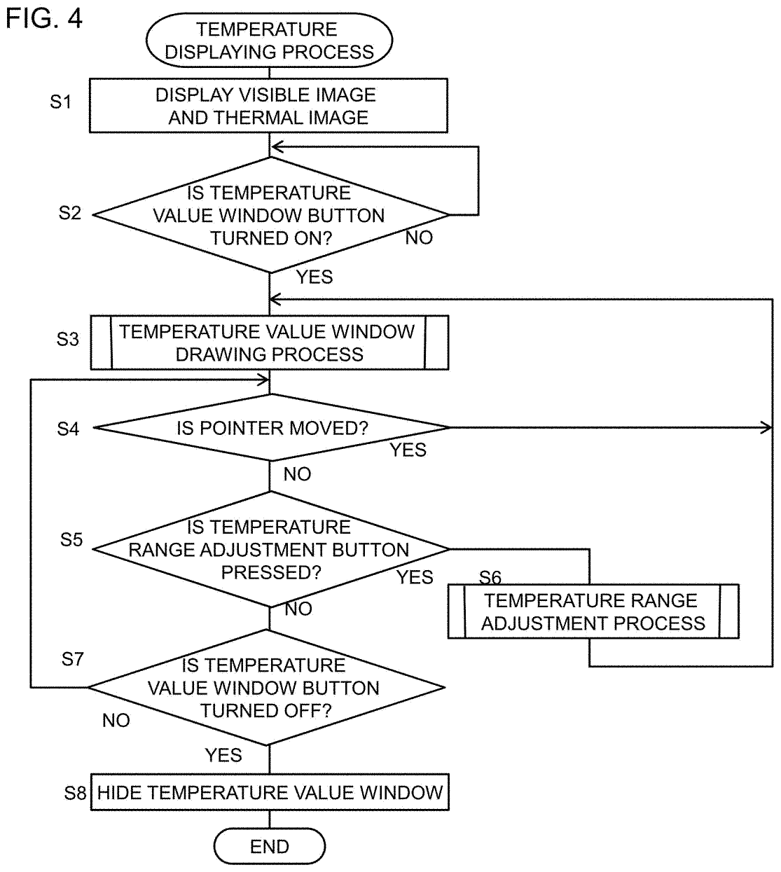

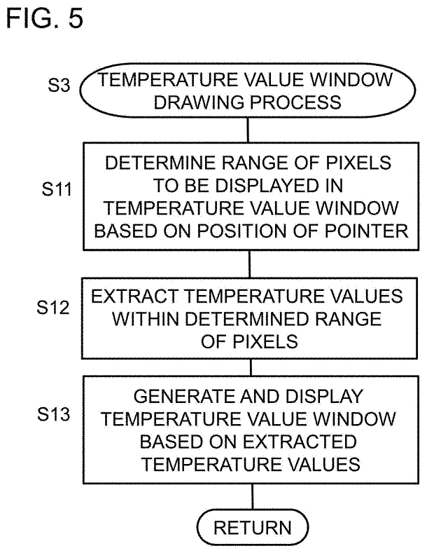

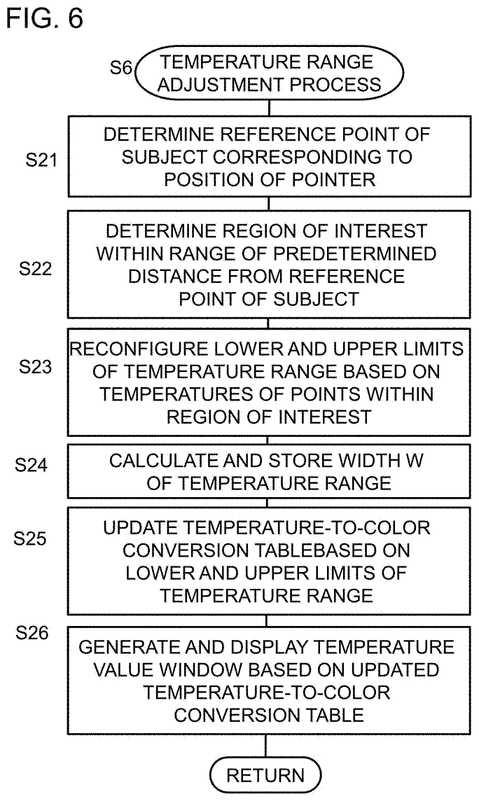

FIG. 4 is a flowchart showing a temperature displaying process executed by the control device 11 of FIG. 1. The process of FIG. 4 (and FIGS. 5 and 6) is executed by the control device 11 running the thermal image displaying application 16a.

At step S1, the control device 11 displays a visible image and a thermal image on the display device 13. The information processing apparatus 10 according to this embodiment has a function of simultaneously displaying the thermal image captured by the infrared camera 18, and the visible image captured by the visible-light camera 17, on the display device 13.

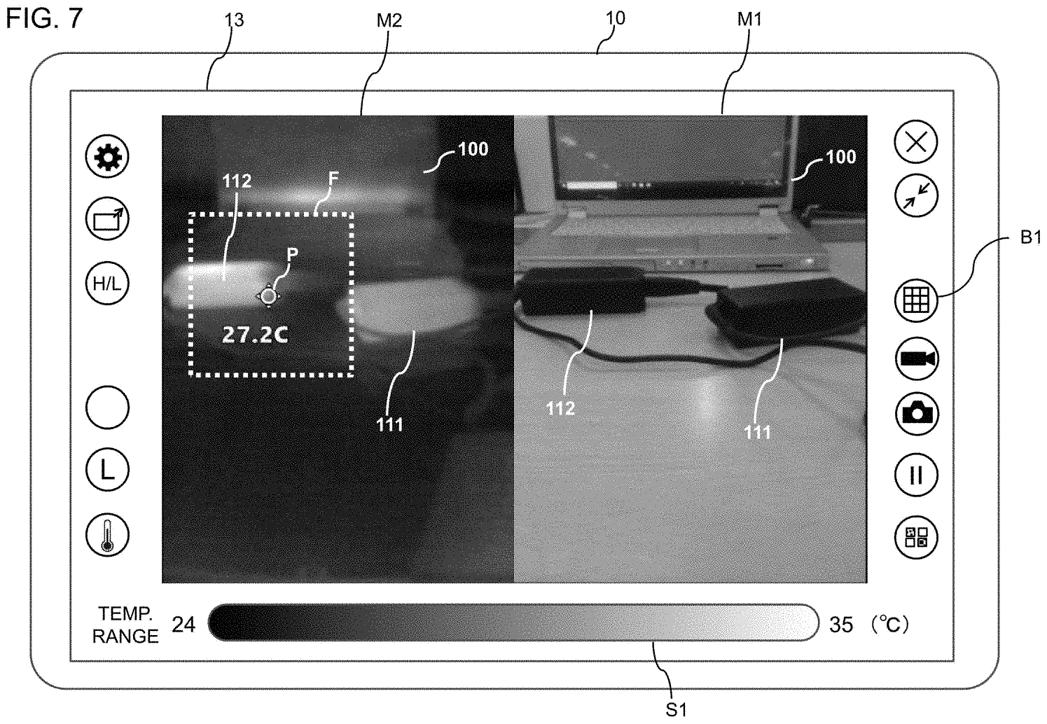

FIG. 7 is a view showing a preview image displayed on the display device 13 of FIG. 1. As shown in FIG. 7, a visible image M1 captured by the visible-light camera 17 and a thermal image M2 captured by the infrared camera 18 are displayed side by side on the display device 13. Each pixel of the thermal image M2 is set with a predetermined color based on the temperature of a point on the subject, the point corresponding to the pixel, and thus, the thermal image M2 indicates a temperature distribution of the subject. In each of the visible image M1 and the thermal image M2, a personal computer 100 and two power adapters 111 and 112 are displayed as subjects.

Various operation buttons are arranged on the right side of the visible image M1 and on the left side of the thermal image M2. A button B1 is a temperature value window button for switching to a temperature value displaying mode in which a temperature value window is displayed (details will be described later). Below the visible image M1 and the thermal image M2, an indicator S1 is displayed that indicates correspondences between colors and temperatures of the thermal image M2.

A pointer P is displayed on the thermal image M2. The temperature of a pixel specified by the pointer P, “27.2° C.”, is displayed near the pointer P, The pointer P specifies a pixel at the center of the temperature value window as described below. The position of the pointer P can be freely changed on the thermal image M2 by touch and/or drag operation by the user.

In addition, a frame F is displayed around the pointer P, the frame F indicating a region of interest within a range of a predetermined distance from a reference point on the subject, the reference point corresponding to the pointer P.

As described above, the visible-light camera 17 and the infrared camera 18 have substantially the same angle of view, and capture substantially the same subject. Therefore, the user can recognize the temperature distribution of the subject from the thermal image M2, while checking the subject by the visible image M1.

Referring again to FIG. 4, at step S2, the control device 11 determines whether or not the button B1 (referred to also as “temperature value window button”) is turned on by the user; if YES, the process proceeds to step S3; if NO, the process repeats step S2. At step S3, the control device 11 changes the operation mode of the information processing apparatus 10 to the temperature value displaying mode, and execute a temperature value window drawing process. In the temperature value window drawing process, the temperature value window is generated and displayed that indicates temperature values of pixels within a range including the pointer P on the thermal image M2.

FIG. 5 is a flowchart showing a subroutine for the temperature value window drawing process at step S3 of FIG. 4,

At step S11, the control device 11 determines a range of pixels to be displayed in the temperature value window, based on the position of the pointer P. The range of pixels to be displayed in the temperature value window are, for example, M×N pixels of the thermal image M2 (M and N are integers centered at the pixel specified by the pointer P.

At step S12, the control device 11 extracts temperature values of pixels within the determined range of M×N pixels.

At step S13, the control device 11 generates the temperature value window based on the extracted temperature values of M×N pixels, and displays it on the display device 13. Specifically, a temperature value window WD has M×N cells (e.g., a rectangular area) arranged two-dimensionally and corresponding to M×N pixels of the thermal image M2, with each cell being allocated with a temperature value of a pixel of the thermal image M2 corresponding to the cell. In addition, the background color of each cell is set to a color corresponding to the temperature value allocated to the cell, based on the temperature-to-color conversion table 16b.

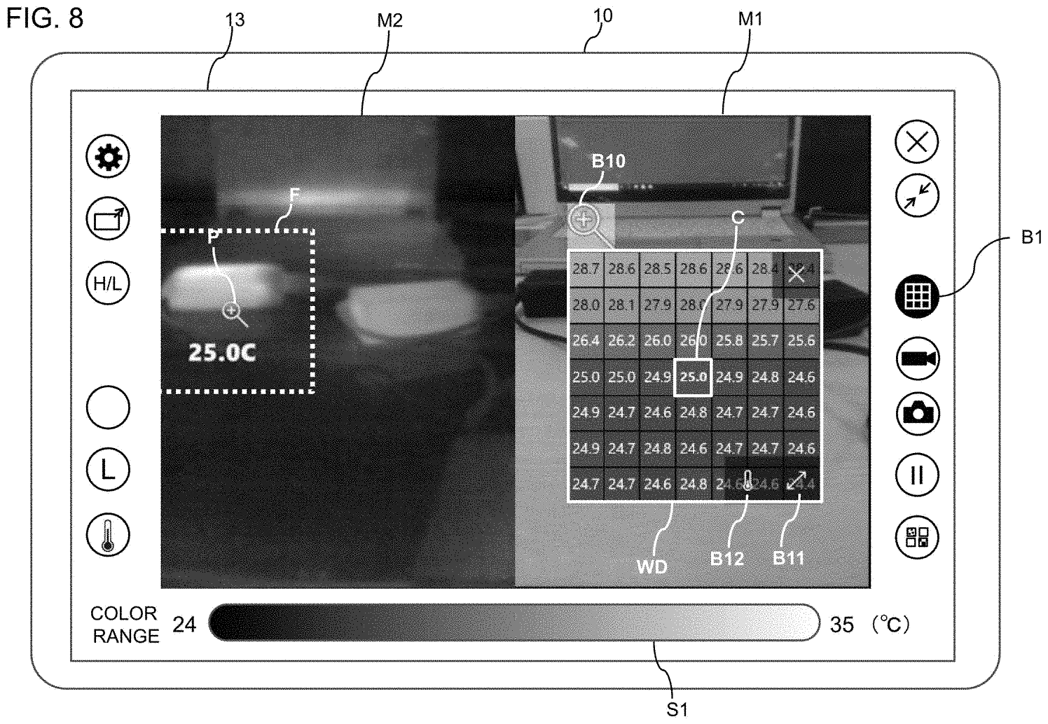

FIG. 8 is a view showing an example of the temperature value window WD displayed on the display device 13 of FIG. 1. For example, the temperature value window WD is displayed overlapping with the visible image M1 (or the thermal image M2). For example, in the example of FIG. 8, the temperature value window WD displays temperature values of 7×7 pixels, centered at a pixel specified by the pointer P on the thermal image M2. A temperature of the pixel specified by the pointer P (25.0° C.) is displayed on a center cell C of the temperature value window WD.

In the example of FIG. 8, the temperature value window WD has buttons B10, B11, and B12 for the user to operate the temperature value window WD. When the user drags the button B10, the temperature value window WD moves on the visible image M1 and the thermal image M2. When the user turns on the button B11, the temperature value window WD is maximized so as to cover the area of the visible image M1. When the user turns on the button B12, a temperature range adjustment process as described below is executed.

Referring again to FIG. 4, at step S4, the control device 11 determines whether or not the pointer P is moved by the user; if YES, the process returns to step S3; if NO, the process proceeds to step S5.

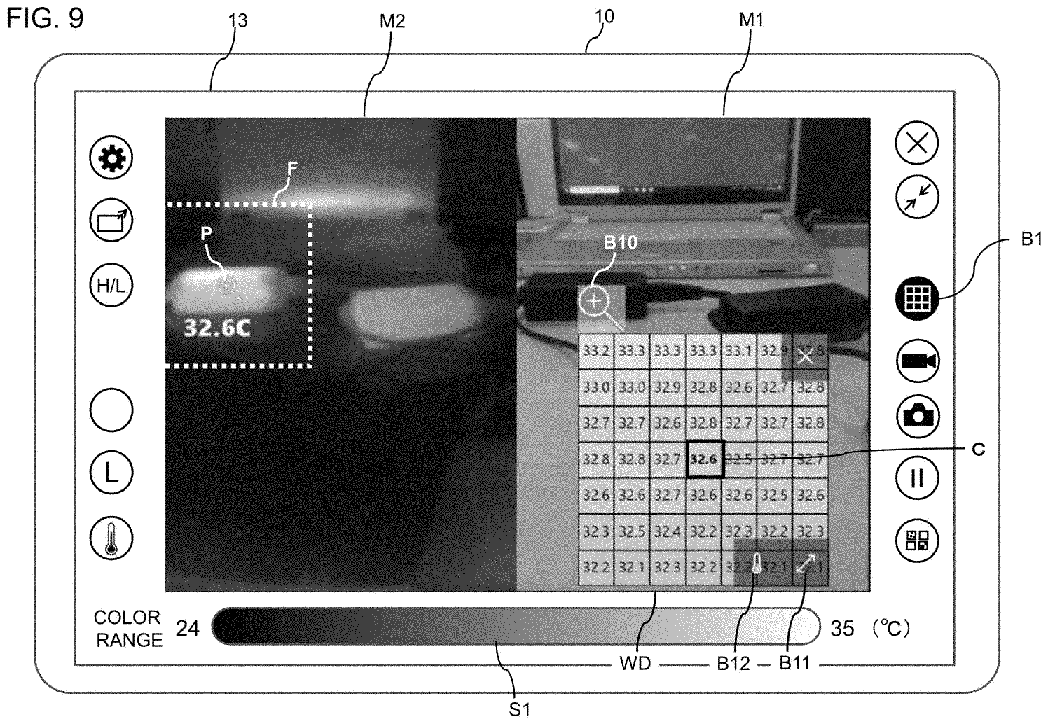

FIG. 9 is a view showing another example of the temperature value window WD displayed on the display device 13 of FIG. 1. The temperature value window WD displays the temperatures within a predetermined range with respect to the position of the pointer P on the thermal image M2, and therefore, when the position of the pointer on the thermal image M2 is changed, the contents of the temperature value window WD are also changed. The pointer P is moved when the user touches a point on the thermal image M2 or drags the pointer P thereon. In the example of FIG. 9, the temperature value window WD displays temperature values of 7×7 pixels different from those in the temperature value window WD of FIG. 8, centered at a pixel specified by the pointer P at a position different from that of the pointer P of FIG. 8. A temperature of the pixel specified by the pointer P (32.6° C.) is displayed on a center cell C of the temperature value window WD. The background color of each cell is set to a color corresponding to the temperature value allocated to the cell, that is different from the background color of each cell of FIG. 8.

When returning from step S4 to step S3 of FIG. 4, the control device 11 again executes the temperature value window drawing process, based on a new position of the pointer P.

At step S5, the control device 11 determines whether or not the button B12 (referred to also as “temperature range adjustment button”) on the temperature value window WD is pressed by the user; if YES, the process proceeds to step S6; if NO, the process proceeds to step S7. At step S6, the control device 11 executes the temperature range adjustment process, and then, the process returns to step S3. The temperature range adjustment process will be described below,

At step S7, the control device 11 determines whether or not the temperature value window button B1 is turned off by the user; if YES, the process proceeds to step S8; if NO, the process returns to step S4. At step S8, the control device 11 hides the temperature value window, and the process ends.

[1-2-2. Temperature Range Adjustment Process]

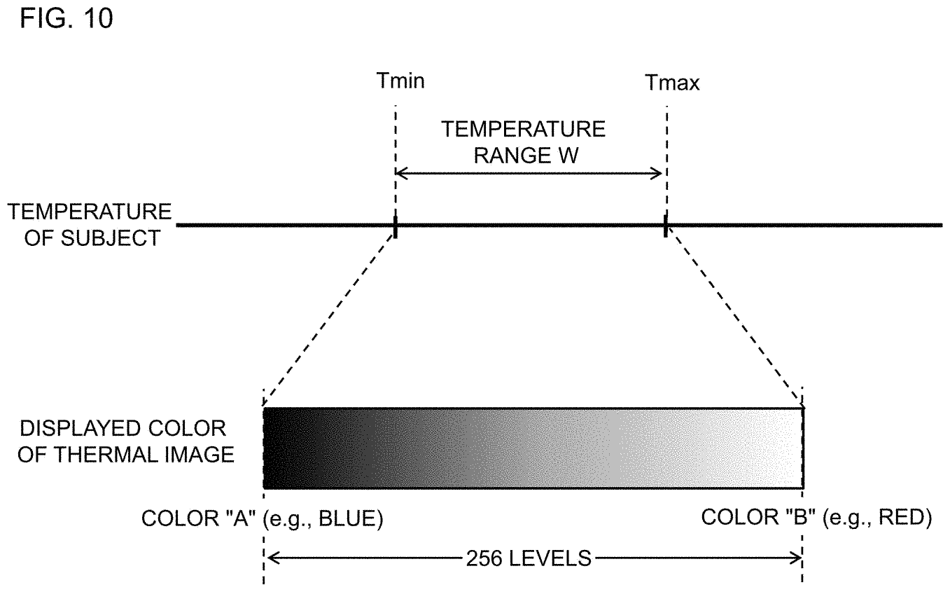

FIG. 10 is a view explaining correspondences between temperatures and displayed colors, displayed on the display device 13 of FIG. 1. As described above, each pixel of the thermal image M2 is set with a predetermined color based on the temperature of a point on the subject, the point corresponding to the pixel. The predetermined color is set correspondingly to each of temperatures within a predetermined width W of the temperature range. In case that the temperature of the pixel changes from a lower limit Tmin to an upper limit Tmax of the width of the temperature range, the pixel color is changed from a color A corresponding to the lower limit Tmin, to a color B corresponding to the upper limit Tmax, depending on the temperature. In this case, the pixel color changes, for example, in 256 steps. The color A corresponding to the lower limit Tmin of the width of the temperature range is, for example, “blue”, and the color B corresponding to the upper limit Tmax of the width of the temperature range is, for example, “red”.

In the examples of FIGS. 8 and 9, the predetermined color is set correspondingly to each of temperatures within the temperature range of 24 to 35° C. Comparing the temperature value windows WD of FIGS. 8 and 9 with each other, the temperature value range of cells in the temperature value window WD of FIG. 9 is narrower than the temperature value range of cells in the temperature value window WD of FIG. 8. Thus, the changes in the background colors of cells in the temperature value window WD of FIG. 9 are less recognizable than the changes in the background colors of cells in the temperature value window WD of FIG. 8.

In case that the temperature value range of cells in the temperature value window WD is narrow, the changes in the background colors of cells in the temperature value window WD would become well recognizable by reconfiguring the correspondences between temperatures and colors of cells according to the temperature range. In this case, it is required to automatically reconfigure the correspondences between temperatures and colors of pixels, without any complicated user operations.

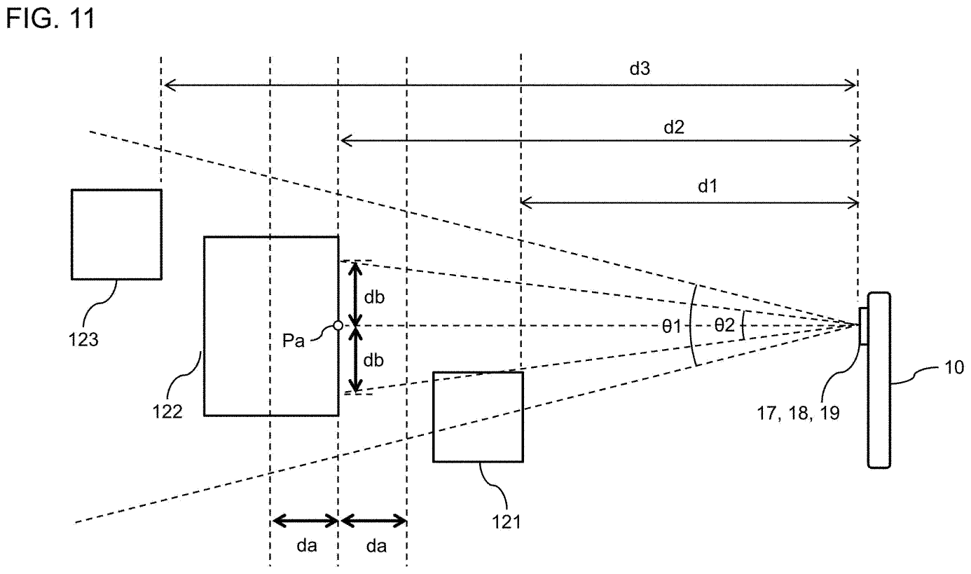

FIG. 11 is a schematic view showing an arrangement of the information processing apparatus 10 of FIG. 1 and subjects 121 to 123. The subject 122 has a reference point Pa corresponding to the pointer P that is set on the information processing apparatus 10 by the user. The subject 122 resides at a distance d2 from the information processing apparatus 10, and the other subjects 121 and 123 reside at distances d1 and d3 from the information processing apparatus 10, the distances d1 and d3 being different from the distance d2.

Referring to FIG. 7, the personal computer 100 and the power adapters 111 and 112 are located at mutually different distances from the information processing apparatus 10 (not shown in FIG. 7). In general, it is considered that a subject of interest to the user about temperature distribution is not a plurality of objects thermally separated from each other (i.e. not conducting heat), but a single object through which heat is conducted. In other words, in the example of FIG. 7, it is considered sufficient for the user to know the temperature distribution of a single object among the personal computer 100 and the power adapters 111 and 112. It is therefore required to determine a region of interest within a range of a predetermined distance from the reference point on the subject, and display the temperatures of points within the region of interest in a well recognizable manner.

Next, it is described how to determine a proper region of interest, and display the temperatures of points within the region of interest in a well recognizable manner.

FIG. 6 is a flowchart showing a subroutine for the temperature range adjustment process at step S6 of FIG. 4.

At step S21, the control device 11 determines a reference point Pa of the subject, the reference point Pa corresponding to the position of the pointer P.

At step S22, the control device 11 determines a region of interest within the range of the predetermined distance from the reference point Pa of the subject. Referring to FIG. 11, the region of interest is set so that its distance from the information processing apparatus 10 is within a range of −da to +da around the distance d2 from the information processing apparatus 10 to the subject 122. Therefore, the subjects 121 and 123 are excluded from the region of interest. In addition, the region of interest is set so that on a plane orthogonal to a straight line extending from the information processing apparatus 10 to the reference point Pa, its distance from the reference point Pa is equal to or less than db. Therefore, a part of the subject 122 remote from the reference point Pa farther than the distance db is excluded from the region of interest.

The visible-light camera 17, the infrared camera 18, and the distance sensor 19 have an angle of view θ1. A part included in the region of interest When seen from the information processing apparatus 10 (a part included in a circle with a radius of the distance db centered at the reference point Pa) has a visual angle θ2. If the distance d2 from the information processing apparatus 10 to the subject 122 is given by the distance sensor, an angle θ2/2 can be calculated based on the distances d2 and db. Then, the size of the frame F indicative of the region of interest on the thermal image M2 can be determined based on the angles θ1 and θ2.

At step S23, the control device 11 reconfigures the lower and upper limits of the temperature range based on the temperatures of points within the region of interest. The lower limit of the temperature range is set to a lowest temperature value among the temperatures of points within the range of the predetermined distance from the reference point Pa. The upper limit of the temperature range is set to a highest temperature among the temperatures of points within the range of the predetermined distance from the reference point Pa.

At step S24, the control device 11 calculates the width of the temperature range from a difference between the set lower and upper limits of the temperature range, and stores the width of the temperature range in the storage device 16.

At step S25, the control device 11 updates the temperature-to-color conversion table 16b based on the lower and upper limits of the temperature range. Specifically, the control device 11 converts the difference between the configured lower and upper limits of the temperature range into color information using a 256-step palette prepared in advance, to update the temperature-to-color conversion table 16b.

At step S26, the control device 11 regenerates the thermal image based on the updated temperature-to-color conversion table 16b, and displays it on the display device 13. Subsequently, the process returns to step S3 of FIG. 4.

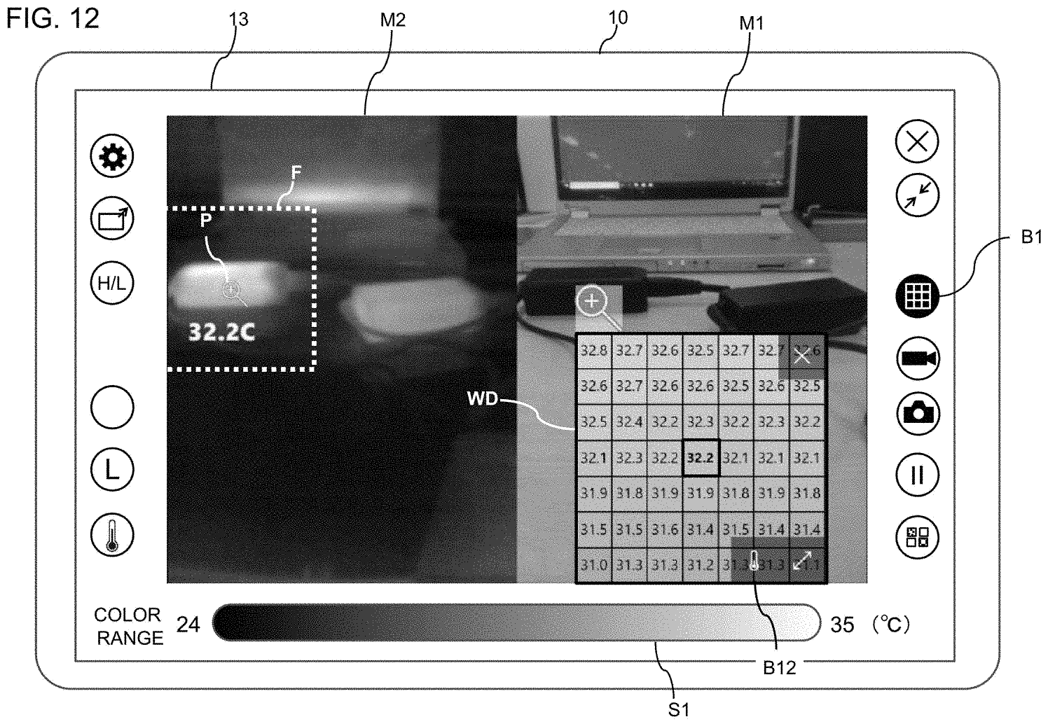

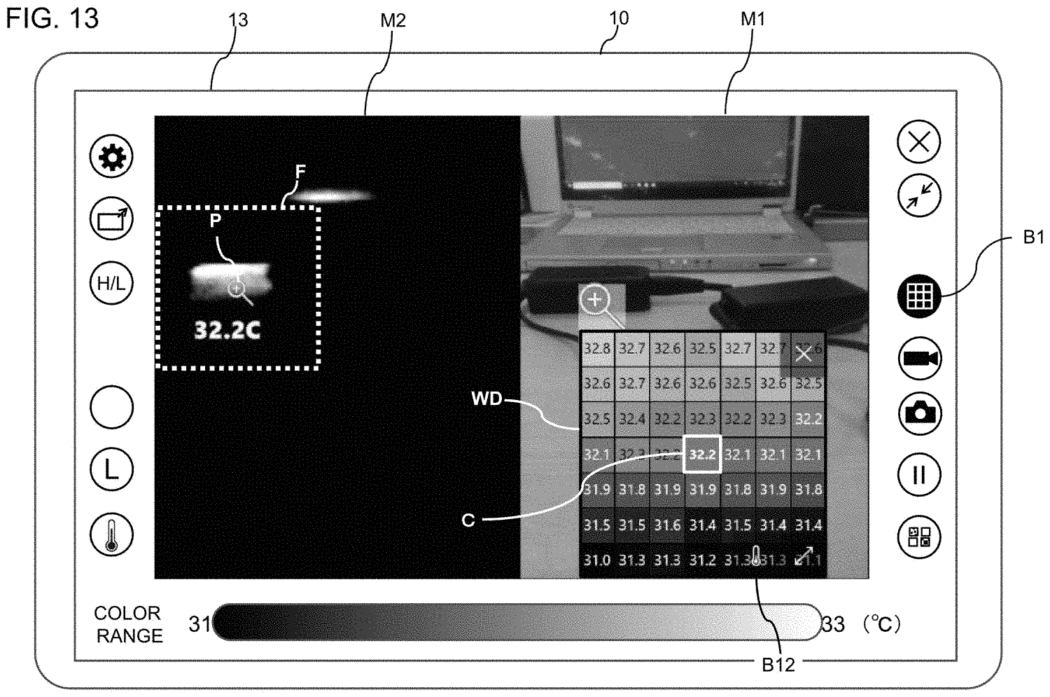

FIG. 12 is a view showing an example of the temperature value window WD displayed on the display device 13 of FIG. 1, in which changes in temperature values are less recognizable. FIG. 13 is a view showing an example of the temperature value window WD displayed on the display device 13 of FIG. 1, in which improvement has been made so that changes in temperature values are well recognizable. FIG. 12 shows the state before executing the temperature range adjustment process of FIG. 6, while FIG. 13 shows the state after executing the temperature range adjustment process of FIG. 6. That is, in the example of FIG. 12, the width of the temperature range is set to 11° C. (=35−24° C). On the other hand, as shown in FIG. 13, the width of the temperature range can be narrowed to 2° C.(=33−31° C.). In the example of FIG. 12, it is difficult to visually distinguish the temperature difference color difference) between the power adapters 111 and 112. On the other hand, by narrowing the width of the temperature range as shown in FIG. 13, it becomes possible to easily recognize that the power adapter 112 is higher in temperature than the power adapter 111. That is, it becomes easier to visually distinguish the temperature difference (color difference) between the power adapters 111 and 112.

As described above, the information processing apparatus 10 according to the present embodiment can display temperatures of points within the region of interest in a well recognizable manner, by identifying a proper region of interest and updating the temperature-to-color conversion table 16b based on the temperatures of points within the region of interest. This makes it easier for the user to intuitively and easily recognize the temperatures of the subject (heat source).

Outside the region of interest, if the temperature of a pixel is less than the lower limit Tmin or higher than the upper limit Tmax, then the pixel may be achromatic (e.g., set to white or black). Alternatively, outside the region of interest, if the temperature of a pixel is less than the lower limit Tmin of the width of the temperature range, then the color of the pixel may be fixed to a color A corresponding to the lower limit Tmin, whereas if the temperature of a pixel is higher than the upper limit Tmax of the width of the temperature range, then the color of the pixel may be fixed to a color B corresponding to the upper limit Tmax.

The infrared camera 18 may be used as the distance sensor 19. In this case, the infrared camera 18 detects the distance from the information processing apparatus 10 to the subject, before or alternately with capturing the thermal image M2.

The information processing apparatus 10 may be provided with means (a user interface or the like) for manually setting the temperature range.

[1-3. Advantageous Effects, Etc.]

The information processing apparatus and the information processing method according to the embodiment of the present disclosure have the following configurations and effects.

The information processing apparatus according to the embodiment of the present disclosure captures and displays a thermal image indicative of temperatures of a subject in colors. The information processing apparatus 10 is provided with: an infrared camera 18, a distance sensor 19, a display device 13, a storage device 16, and a control device 11. The infrared camera 18 captures the subject to generate the thermal image of the subject. The distance sensor 19 detects distances from the information processing apparatus 10 to points on the subject. The display device 13 displays the thermal image. The storage device 16 stores a temperature-to-color conversion table indicative of correspondences between temperatures of the subject and pixel colors. The control device 11 processes the thermal image based on the temperature-to-color conversion table, to display the processed thermal image on the display device 13. The control device 11 identifies a region of interest within a range of a predetermined distance from a reference point of the subject, based on the distances detected by the distance sensor 19. The control device 11 sets lower and upper limits of a temperature range based on temperatures of points within the region of interest. The control device 11 updates the temperature-to-color conversion table based on the lower and upper limits of the temperature range. The control device 11 regenerates the thermal image based on the updated temperature-to-color conversion table, to display the regenerated thermal image on the display device 13.

Thus, it is possible to display temperatures of points within the region of interest in a well recognizable manner, by identifying a proper region of interest and updating the temperature-to-color conversion table 16b based on the temperatures of points within the region of interest. This makes it easier for the user to intuitively and easily recognize the temperatures of the heat source.

The information processing apparatus according to the embodiment of the present disclosure may be configured such that the control device 11 generates a temperature value window WD indicative of temperature values of pixels within a region including a position specified on the thermal image, to display the temperature value window WD on the display device 13. The temperature value window WD has a plurality of cells arranged two-dimensionally and corresponding to pixels of a partial region of the thermal image, each of the cells having a numerical value indicative of a temperature and arranged thereon, each of the cells having a background color that is set based on the temperature of the cell and based on the temperature-to-color conversion table.

Thus, the user can intuitively and easily recognize the temperatures of the heat source.

The information processing apparatus according to the embodiment of the present disclosure may be configured such that the information processing apparatus 10 is further provided with: a visible-light camera 17 that captures a subject identical to the subject of the thermal image, with visible light, to generate a visible image of the subject. The display device 13 may further display the visible image juxtaposed with the thermal image.

Thus, the object represented by the thermal image is made well recognizable.

The information processing apparatus according to the embodiment of the present disclosure may be a tablet terminal device.

Thus, it is possible to easily provide a useful information processing apparatus.

The information processing method according to the embodiment of the present disclosure captures and displays a thermal image indicative of temperatures of a subject in colors. The method including the steps of: capturing the subject by an infrared camera 18 to generate a thermal image of the subject; detecting distances from the infrared camera 18 to points on the subject by a distance sensor 19; processing the thermal image based on a temperature-to-color conversion table indicative of correspondences between temperatures of the subject and pixel colors; and displaying the processed thermal image on a display device 13. The step of processing the thermal image includes the steps of: identifying a region of interest within a range of a predetermined distance from a reference point of the subject, based on the distances detected by the distance sensor 19, setting lower and upper limits of a temperature range, based on temperatures of points within the region of interest, updating the temperature-to-color conversion table based on the lower and upper limits of the temperature range, and regenerating the thermal image based on the updated temperature-to-color conversion table.

Thus, it is possible to display temperatures of points within the region of interest in a well recognizable manner, by identifying a proper region of interest and updating the temperature-to-color conversion table 16b based on the temperatures of points within the region of interest. This makes it easier for the user to intuitively and easily recognize the temperatures of the heat source.

### Other Embodiments

As described above, the embodiment has been described as examples of the technology disclosed in the present application. However, the technology of the present disclosure is not limited thereto, and can be applied to embodiments with some change, replacement, addition, omission, and the like. In addition, new embodiments can be derived by combining the components described in the aforementioned embodiment. Thus, other embodiments will be exemplified below.

Although the above embodiment is described with reference to the tablet terminal device as the example of the information processing apparatus, the idea of the present disclosure is also applicable to other types of electronic equipment. For example, the idea of the present disclosure is applicable to electronic equipment, such as smartphones, laptop personal computers (PCs), and desktop PCs.

The values of the number of pixels and the number of gradations (steps) are mere examples, and are not limited to the above values.

The thermal image displaying application 16a and the temperature-to-color conversion table 16b may be installed from portable recording media, such as optical disks or memory cards, into the information processing apparatus 10, or may be downloaded from a server(s) over a network.

As described above, the embodiments have been described as examples of the technology disclosed in the present application. To that end, the accompanying drawings and the detailed description have been provided.

Accordingly, the constituent elements described in the accompanying drawings and the detailed description may include not only constituent elements essential to solving the problem, but also constituent elements not essential to solving the problem, in order to exemplify the technique. Therefore, even when those non-essential constituent elements are described in the accompanying drawings and the detailed description, those non-essential constituent elements should not be considered essentials.

In this specification, the steps of the program stored in the record medium include not only processes to be performed in chronological order according to the present disclosure, but also processes to be performed not necessarily in chronological order, that is, processes to be executed in parallel or individually.

In addition, since the above-described embodiments are intended to exemplify the technique of the present disclosure, it is possible to make various changes, replacements, additions, omissions, and the like within the scope of claims or the equivalent thereof.

The information processing apparatus according to the aspect of the present disclosure can present temperatures of a subject to the user in an intuitively and easily recognizable manner. Accordingly, the information processing apparatus of the present disclosure is useful for a device that presents the temperatures of the subject to the user.

1. An information processing apparatus capturing and displaying a thermal image indicative of temperatures of a subject in colors, the information processing apparatus comprising:
an infrared camera that captures the subject to generate the thermal image of the subject;
a distance sensor that detects distances from the information processing apparatus to points on the subject;
a display device that displays the thermal image;
a storage device that stores a temperature-to-color conversion table indicative of correspondences between temperatures of the subject and pixel colors; and
a control device that processes the thermal image based on the temperature-to-color conversion table, to display the processed thermal image on the display device,
wherein the control device identifies a region of interest within a range of a predetermined distance from a reference point of the subject, based on the distances detected by the distance sensor,
wherein the control device sets lower and upper limits of a temperature range based on temperatures of points within the region of interest,
wherein the control device updates the temperature-to-color conversion table based on the lower and upper limits of the temperature range, and
wherein the control device regenerates the thermal image based on the updated temperature-to-color conversion table, to display the regenerated thermal image on the display device.

2. The information processing apparatus of claim 1,
wherein the control device generates a temperature value window indicative of temperature values of pixels within a region including a position specified on the thermal image, to display the temperature value window on the display device, and
wherein the temperature value window has a plurality of cells arranged two-dimensionally and corresponding to pixels of a partial region of the thermal image, each of the cells having a numerical value indicative of a temperature and arranged thereon, each of the cells having a background color that is set based on the temperature of the cell and based on the temperature-to-color conversion table.

3. The information processing apparatus of claim 1, further comprising:
a visible-light camera that captures a subject identical to the subject of the thermal image, with visible light, to generate a visible image of the subject,
wherein the display device further displays the visible image juxtaposed with the thermal image.

4. The information processing apparatus of claim 1,
wherein the information processing apparatus is a tablet terminal device.

5. An information processing method capturing and displaying a thermal image indicative of temperatures of a subject in colors, the method including the steps of:
capturing the subject by an infrared camera to generate a thermal image of the subject;
detecting distances from the infrared camera to points on the subject by a distance sensor;
processing the thermal image based on a temperature-to-color conversion table indicative of correspondences between temperatures of the subject and pixel colors; and
displaying the processed thermal image on a display device,
wherein the step of processing the thermal image includes the steps of:
identifying a region of interest within a range of a predetermined distance from a reference point of the subject, based on the distances detected by the distance sensor,
setting lower and upper limits of a temperature range, based on temperatures of points within the region of interest,
updating the temperature-to-color conversion table based on the lower and upper limits of the temperature range, and
regenerating the thermal image based on the updated temperature-to-color conversion table.
